(19) United States
(12) Patent Application Publication
(10) Pub. No.: US 2019/0030875 A1
(43) Pub. Date: Jan. 31, 2019

(54) SEALING MEMBRANE FOR A ROOF

(71) Applicant: S.A. IMPERBEL N.V., Lot (BE)

(72) Inventors: Renaud Verdebout, Gembloux (BE); Damien Franssen, Mehaigne (BE); Hans Aerts, Zellik (BE)

(73) Assignee: S.A. IMPERBEL N.V., Lot (BE)

(21) Appl. No.: 16/071,885

(22) PCT Filed: Jan. 25, 2017
(86) PCT No.: PCT/EP2017/051563

§ 371 Date: Jul. 20, 2018

(30) Foreign Application Priority Data
Jan. 25, 2016 (EP) 16152610.8

(51) Int. Cl. B32B 27/36; B32B 27/32; B32B 27/20; B32B 5/02; B32B 11/10; B32B 27/12; D06N 5/00

(52) U.S. Cl. CPC B32B 27/36; D06N 2209/1678; B32B 27/20; B32B 5/022; B32B 5/024; B32B 11/10; B32B 27/12; D06N 5/003; B32B 2307/7265; B32B 2307/71; B32B 2307/518; B32B 2262/0276; B32B 2262/101; B32B 2419/06; D06N 2209/128; D06N 2209/0876; D06N 2209/10; B32B 27/32

(57) ABSTRACT

The invention relates to a sealing membrane for a roof, comprising: an upper layer made from a polymer material, a lower sealing layer arranged to cover the roof, and a reinforcement disposed between the upper layer and the lower layer, characterised in that the polymer material is bi-oriented.

The present invention relates to a waterproofing membrane for a roof.

A known waterproofing membrane typically comprises an upper layer made from a polymer material which is arranged to reflect UV rays, a lower waterproofing layer which is arranged to cover a roof, and a reinforcement disposed between said upper layer and said lower layer.

Document WO 2004/070107 discloses a bituminous membrane which comprises a reinforcement equipped on a first face of a bituminous mass and on a second face of a mixture constituted of an acrylic polymer and titanium dioxide (TiO₂).

When the reflective membrane is applied, for example on a roof of a building, the layer comprising the mixture constituted of the acrylic polymer and the TiO₂ makes it possible to protect the membrane from UV rays. The function of this layer is therefore to form a barrier against UV rays such that the latter cannot come into contact with the bituminous mass present on the first face of the reinforcement.

The reflective layer is obtained by directly applying the mixture constituted of an acrylic polymer and TiO₂ on the second face of the reinforcement, which is then dried during the implementation of the membrane which is brought to the level of the bitumen bath where the first face of the reinforcement can be impregnated with bitumen. Then, the membrane is dried again to obtain an end product.

Unfortunately, during the application of the above-cited mixture on the second face of the reinforcement, the mixture constituted of acrylic polymer and TiO₂ can have a viscosity which varies, which can lead to the sedimentation of a part of the components of the mixture which is not subsequently consistent enough. The dispersion of the TiO₂ can no longer subsequently be guaranteed in the membrane. Consequently, the reflectivity of the membrane decreases over time, making it less effective, when it covers the roof of a dwelling or of a building.

More specifically, the protective layer which comprises the acrylic polymer and the TiO₂ which is not sufficiently dispersed in the mixture, thus no longer plays the role of a barrier against the passage of the UV rays.

The fact that the membrane is no longer capable of reflecting UV rays from the sun, these UV rays can thus more easily reach the bituminous mass of the membrane, which leads to environmental pollution.

More specifically, when UV rays come into contact with the bituminous mass and the oil that it contains, the oil rises to the surface of the membrane. This exudation phenomenon connected to the migration of the oil to the surface of the membrane causes environmental pollution, when rainwater is mixed with this oil which is no longer contained in the bituminous mass.

Therefore, there is a need to provide a waterproofing membrane of which the lifespan is extended and which reduces the risk connected to the exudation phenomenon, existing when the waterproofing membrane comprises bitumen.

The invention thus aims to overcome the disadvantages of the state of the art by providing a waterproofing membrane for a roof which has an extended lifespan with respect to known membranes and which considerably decreases the risk connected to the exudation phenomenon, when the membrane comprises bitumen.

To resolve this problem, a waterproofing membrane for a roof is provided, according to the invention, such as indicated at the start, characterised in that said polymer material is bi-oriented.

The use of a bi-oriented polymer material enables to give the waterproofing membrane advantageous properties, in particular in terms of mechanical performance, chemical resistance, protection against UV rays and reflectivity.

Indeed, it is known to a person skilled in the art, that the absorption of UV rays by a membrane for a roof, significantly reduces the lifespan of it. This phenomenon is due to degradation reactions which could be passed to different layers of the membrane for a roof. These degradation reactions come, for example, from photochemical reactions, oxidation, or the increase in temperature of the membrane. These degradation reactions can be conveyed in certain cases by a yellowing of said polymer material. The degradation of the membrane can lead to the obtaining of a membrane of which the waterproofing is reduced.

In addition, the absorption of sunrays by the membrane significantly increases the temperature of the building on which the membrane is fixed. This can contribute, for example, to increasing energy costs connected to the air conditioning of the buildings in hot countries.

The membrane's permeability to oxygen and water is also a factor to consider. Indeed, oxygen and water can contribute to the degradation of the membrane through respectively oxidation and hydrolysis reactions. The use of a bi-oriented polymer layer can enable to advantageously limit the membrane's permeability to oxygen and water and therefore limit the impact of problems arising from it.

Another advantage also resides in the fact that oil could be contained in the lower waterproofing layer, for example, when it comprises bitumen, can be kept in this layer for the lifespan of the membrane in order to avoid any migration of oil following the above-cited exudation phenomenon. This constitutes a real advantage in that the environmental impact of the waterproofing membrane according to the invention is considerably reduced when it preferably contains bitumen.

An additional advantageous characteristic resides in the fact that the upper layer made from a bi-oriented polymer material makes it possible to improve the adhesion between it and the other layers forming the waterproofing membrane according to the invention.

Thus, when the waterproofing membrane according to the present invention is placed on a roof, a possible stagnation of the membrane under water can take place. In this scenario, it has been observed that the use of the above-cited upper layer makes it possible to have a waterproofing membrane of which the layers sufficiently bond to each other, which makes it possible to avoid a delamination of the membrane.

The lifespan of the membrane according to the invention is thus guaranteed over time, even in case of stagnation under water thanks to the cohesion of all the layers forming the waterproofing membrane according to the invention.

In addition, it has been observed that the waterproofing membrane according to the invention has an extended lifespan with respect to current membranes. Indeed, the deposit of algae or bacteria and the growth of fungi or lichens on the membrane are considerably reduced, thanks to the waterproofing membrane which has a sufficiently smooth surface.

Moreover, keeping these waterproofing membranes substantially smooth on the surface is facilitated, which is particularly advantageous for the user.

Advantageously, said bi-oriented polymer material is selected from the group constituted of polypropylene, polyester and the mixtures thereof.

In a specific embodiment, said upper layer made from a bi-oriented polymer material is a bi-oriented polyester multilayer.

Preferably, said polyester is selected from the group constituted of poly(ethylene terephthalate) (PET), poly(ethylene naphthalate) (PEN) and poly(butylene terephthalate) (PBT) and the mixtures thereof.

Particularly preferably, said bi-oriented polyester multilayer comprises a pigment selected from the group constituted of titanium dioxide (TiO₂), barium sulphate, calcium carbonate and the mixtures thereof.

In a particularly advantageous embodiment of the device according to the invention, said bi-oriented polyester multilayer comprises a first outer layer, a second outer layer, connected to each other by a central layer.

In addition, in a specific embodiment, said central layer comprises TiO₂ in a quantity of between 0.1-40% by weight, preferably between 0.5-30% by weight, more preferably between 0.6-0.75% by weight, more preferably still between 0.65-0.75% by weight, with respect to the total weight of the central layer.

Preferably, said first outer layer and/or said second outer layer comprises TiO₂ in a quantity less than 5% by weight, preferably less than 4% by weight, more preferably between 0.01-3% by weight, with respect to the total weight of the first outer layer and/or the second outer layer.

More preferably, said first outer layer and/or said second outer layer comprises PET.

According to an advantageous embodiment, said PET has an average molecular weight by number in the range from 18,500-40,000, preferably ranging from 19,000-35,000, more preferably ranging from 20,000-30,000.

Advantageously, said PET has carboxyl groups in a quantity less than or equal to 30 eq/T, preferably less than or equal to 25 eq/T, more preferably less than or equal to 21 eq/T, more preferably still less than or equal to 15 eq/T, advantageously between 5-15 eq/T.

In a particularly preferred embodiment, said first outer layer and/or said second outer layer comprises a stabilising light agent to absorb UV rays and reduce the effect of oxygen on the waterproofing membrane, said agent being selected from the group constituted of antioxidants, benzophenones, benzotriazoles, benzoxazinones, triazines, a triazine have 2 phenyl groups or 2 bi-phenyl groups and the mixtures thereof.

According to a particularly preferred embodiment, said upper layer made from a polymer material has a thickness of between 3 and 500 μm, advantageously between 10 and 350 μm; 50 and 200 μm, preferably between 80 and 190 μm, more preferably between 180 and 190 μm.

Preferably, the membrane according to the invention is a reflective membrane. Advantageously, the lower waterproofing layer is a bitumen-based layer, preferably a modified bitumen with a polymer or a vegetable binder base or a bitumen mixture base, preferably a modified bitumen with a polymer and a vegetable binder.

The lower layer can preferably be a vegetable binder base layer which also gives a sealed character to the membrane.

Other embodiments of the membrane according to the invention are indicated in the appended claims.

The invention also aims for a method of producing a waterproofing membrane, said method comprising the following steps:

making a reinforcement having a first face and a second face available,

applying a lower waterproofing layer on said first face of said reinforcement,

applying an upper layer made from a bi-oriented polymer material on said second face of said reinforcement.

Preferably, said step of applying said upper layer made from a bi-oriented polymer material consists of binding said above-cited upper layer on said second face of said reinforcement.

Other embodiments of the method according to the invention are indicated in the appended claims.

Other characteristics, details and advantages of the invention will emerge in the description given below, in a non-limitative way and by making reference to the appended drawings.

The waterproofing membrane according to the present invention can be used to cover a roof of a building or of a dwelling.

The waterproofing membrane according to the present invention can also be used to cover a front of a dwelling or of a building.

The waterproofing membrane according to the present invention can further be used to recover rainwater. As explained above, the exudation phenomenon is reduced, which enables to avoid the migration of oil until the surface of the membrane when it comprises bitumen. Thus, rainwater does not come into contact with oils which remain housed in the lower waterproofing layer.

It must be noted that the lower waterproofing layer can advantageously comprise vegetable oils.

The recovery of rainwater is therefore facilitated, which constitutes a real advantage of the waterproofing membrane according to the present invention.

In addition, the placement of a series of waterproofing membranes according to the present invention on a roof of a dwelling can consist of superimposing a first membrane on a second membrane by superimposing the first end of the lower waterproofing layer of the first membrane on the first end of the upper layer made from a bi-oriented polymer material of the second membrane. This type of membrane can be applied on a roof.

During the placement, it has been observed that the lower waterproofing layer combines with the upper layer made from a bi-oriented polymer material which enables to provide a totally sealed membrane, preferably against water.

Indeed, the cohesion between the lower layer of the first membrane and the upper layer of the second membrane is guaranteed over time, as well as between the layers which form the waterproofing membranes according to the present invention.

In addition, the membrane according to the invention resists water which is particularly advantageous when it covers a roof.

According to a first embodiment, the method of producing the waterproofing membrane according to the invention consists of implementing a reinforcement having a first face and a second face and of preferably applying, by bonding, an upper layer, possibly reflective, made from a bi-oriented polymer material on the second face of the reinforcement. The adhesion between the upper layer and the second face of the reinforcement can be done by lamination.

The reinforcement equipped with the upper layer is then brought towards a bath comprising a bitumen-based composition or a vegetable binder base, so as to impregnate the first face of the reinforcement of said bitumen-based composition or a vegetable binder base. Then, the membrane can be dried.

According to a second embodiment, the method of producing the waterproofing membrane according to the invention consists of implementing, preferably continuously, a reinforcement having a first face and a second face and of bringing it towards a bath comprising a bitumen-based composition or a vegetable binder base so as to impregnate the first face of the reinforcement of said bitumen-based composition or vegetable binder base. Then, the membrane can be dried.

Then, an upper layer, possibly reflective, made from a bi-oriented polymer material is applied on the second face of the reinforcement equipped with the above-cited lower waterproofing layer.

This application can consist of binding the upper layer on the second face of the reinforcement. The adhesion between the upper layer and the second face of the reinforcement can also be done by lamination.

According to a third embodiment, the method of producing the waterproofing membrane according to the invention consists of implementing a reinforcement having a first face and a second continuous face and of bringing it towards a bath comprising a bitumen-based composition or a vegetable binder base, so as to impregnate the first face of the reinforcement of said bitumen-based composition or vegetable binder base. In this way, the second face of the reinforcement can also be covered by said bitumen-based composition or vegetable binder base. Then, an upper layer, possibly reflective, made from a bi-oriented polymer material is applied on the second face of the reinforcement. The adhesion between the upper layer and the second face of the reinforcement being obtained thanks to the presence of the bitumen-based composition or vegetable binder base.

A method of applying a bituminous mass on a reinforcement is defined in document WO 97/24485, which is incorporated by reference in the scope of the method of applying a bitumen-based composition on a face of a reinforcement.

The membrane thus obtained at the end of the production cycle can be cut and possibly wound in the form of a coil.

A laminator that is static or functioning continuously can be used to produce the waterproofing membrane according to the present invention by means of techniques known to a person skilled in the art.

The laminator can advantageously be selected from the KFK range provided by the company Meyer (Maschinenfabrik Herbert Meyer GmbH), in particular, the devices named KFK-V, KFK-X, KFK-E.

The reinforcement according to the present invention can advantageously be a glass mat or a fibre layer, preferably made from polyester, more preferably made from woven or non-woven polyester.

The upper layer made from a bi-oriented polymer material is advantageously transparent or coloured, preferably white or grey.

It can be produced by the method defined in application WO 2012/104668, which is incorporated by reference to the present invention.

The upper layer made from a bi-oriented polymer material can have a thickness of between 3 and 500 μm, advantageously between 10 and 350 μm; 50 and 200 μm, preferably between 80 and 190 μm, more preferably between 180 and 190 μm.

In addition, the upper layer made from a bi-oriented polymer material can comprise a flame retardant.

Preferably, the upper layer made from a bi-oriented polymer material comprises a radical scavenger.

The upper layer made from a bi-oriented polymer material is advantageously equipped with at least one coating on at least one of the faces thereof. This coating can be obtained by coextrusion, by a coating method, by a method of coating by lamination extrusion, by means of a corona treatment in ambient air or gas, by vacuumed evaporation, by a plasma treatment or by a physicochemical vacuum deposit. Preferably, the coating present on at least one of the two faces is obtained by applying a chemical surface treatment, for example, using a coating method which calls upon a polyurethane, polyester, co-polyester or acrylic-based composition.

Such a coating is defined in document WO 2012/104668 and is thus incorporated by reference in the present invention.

According to a preferred embodiment, the upper layer made from a bi-oriented polymer material is a polyester single-layer or multilayer.

The polyester layers forming the multilayer of the upper layer made from a bi-oriented polymer material can, for example, be linear aromatic polyesters, obtained from an aromatic dibasic acid or an ester derived from said acid and also from a diol or from an ester derived form said diol.

Aromatic polyesters are defined in application WO 2012/104668 and are incorporated by reference in the present invention.

Advantageously, the polyester constituting the above-cited multilayer can be selected from the group constituted of known polyesters to be able to form the bi-oriented semi-crystalline layers.

The bi-oriented polyester multilayer according to the present invention can, for example, contain PET or PET co-polyesters containing cyclohexyl dimethylol units instead of ethylene units or the mixtures thereof or PET co-polyesters with a polyester part having isophthalate units or the mixtures thereof.

It is understood that the bi-oriented polyester multilayer according to the present invention can have several layers of an identical or different type.

Advantageously, the PET according to the present invention can have a hydraulic resistance with an intrinsic, increased viscosity value which could be greater than 0.78 dL/g, measured according to the method defined in document WO 2012 104 668, which is incorporated by reference to the present invention. In addition, the quantity of carboxylic group is low and can be less than 15 eq/T, measured according to the method defined in document WO 2012 104 668, which is incorporated by reference to the present invention. This type of PET preferably has an average molecular weight by number of between 18,500 and 40,000, measured according to the method defined in document WO 2012 104 668, which is incorporated by reference to the present invention.

According to a preferred embodiment of the present invention, the bi-oriented polyester multilayer comprises a light stabilising agent. The light stabilising agent is, for example, at least one of the agents defined in application WO 2012 104 668, which are incorporated by reference to the present invention.

Preferably, the bi-oriented polyester multilayer can comprise at least 3 polyester layers, respectively a first outer layer, a second outer layer, connected to each other by a central layer.

The first outer layer and the second outer layer can be made from the same material or from a separate material.

At least one of the 3 above-cited layers comprises PET which can, in particular, have characteristics which have been cited above.

Preferably, the first outer layer and/or the second outer layer comprises PET.

The PET used in the scope of the present invention can have an average molecular weight by number within the range going from 18,500-40,000, preferably ranging from 19,000-35,000, more preferably ranging from 20,000-30,000, determined according to the measuring method defined in document WO 2012104668.

In addition, according to a particularly preferred embodiment, the PET according to the present invention comprises carboxyl groups in a quantity less than or equal to 30 eq/T, preferably less than or equal to 25 eq/T, more preferably less than or equal to 21 eq/T, more preferably still, less than or equal to 15 eq/T, advantageously between 5-15 eq/T, determined according to the measuring method defined in document WO 201204668.

The bi-oriented polyester multilayer can comprise a pigment selected from the group constituted of TiO₂, barium sulphate, calcium carbonate and the mixtures thereof such that the membrane can reflect UV rays from the sun.

The central layer can comprise TiO₂ in a quantity of between 0.1-40% by weight, preferably between 0.5-30% by weight, more preferably between 0.6-0.75% by weight, more preferably still, between 0.65-0.75% by weight.

The first outer layer and/or said second outer layer can comprise TiO₂ in a quantity less than 5% by weight, preferably less than 4% by weight, more preferably between 0.01-3% by weight.

The method for producing the bi-oriented polyester multilayer comprising at least 3 polyester layers is, preferably, that defined in application WO 2012/104668.

The bitumen-based, lower waterproofing layer is preferably made from modified bitumen with a polymer which could be selected from the group constituted of atactic polypropylene (APP), poly(styrene-butadiene-styrene) (SBS), polystyrene-b-poly(ethylene butylene)-b-polystyrene (SEBS), polystyrene-b-poly(ethylene-propylene)-b-polystyrene (SEPS), dimethyl-gamma-butyrolactone acrylate (DBA), styrene-isoprene-styrene (SIS), ethylene vinyl acetate (EVA), isotactic polypropylene (IPP), syndiotactic polypropylene (SPP) and the mixtures thereof.

Alternatively, the lower waterproofing layer can be of a vegetable binder base, such as the commercial product named DERBIPURE, available from the company Imperbel.

More preferably, the lower waterproofing layer can be of a modified or unmodified vegetable binder base with a polymer.

More preferably still, the lower waterproofing layer can be of a modified vegetable binder base with a polymer selected from the group constituted of atactic polypropylene (APP), poly(styrene-butadiene-styrene) (SBS), polystyrene-b-poly(ethylene butylene)-b-polystyrene (SEBS), polystyrene-b-poly(ethylene-propylene)-b-polystyrene (SEPS), dimethyl-gamma-butyrolactone acrylate (DBA), styrene-isoprene-styrene (SIS), ethylene vinyl acetate (EVA), isotactic polypropylene (IPP), syndiotactic polypropylene (SPP) and the mixtures thereof.

The bitumen-based or vegetable binder base lower layer can comprise oil.

The waterproofing membrane according to the present invention can advantageously comprise a charge, other than TiO₂, selected from the group constituted of calcium carbonate, calcium oxide, aluminium oxide, kaolinite, silica, zinc oxide, black carbon, silicon carbide, tin oxide, reticulated acrylic resin particles, reticulated polystyrene resin particles, reticulated melanin resin particles, reticulated silicone resin particles and the mixtures thereof.

In addition, the waterproofing membrane according to the present invention can also comprise an additive such as a radical scavenger, a flame retardant, an antioxidant, an organic oil, a catalyst or any other equivalent additive.

In the scope of the present invention, the waterproofing membrane can be recycled which constitutes a real advantage with respect to known membranes.

The membrane according to the invention can advantageously reflect and/or block and/or absorb UV rays.

### EXAMPLE 1

An upper layer made from a bi-oriented polymer material is constituted of three polyester layers, respectively a first outer layer made from PET, a second outer layer made from PET, connected to each other by a central layer constituted of PET and TiO₂, thus forming a bi-oriented polyester multilayer.

A polyester reinforcement comprises a first face and a second face which is equipped with the above-cited bi-oriented polyester multilayer. The first face of the reinforcement is impregnated with a bitumen-based lower layer, modified with APP. This enables to form a reflective membrane according to the present invention.

The type of reinforcement is not limited to that cited in the present example and can therefore advantageously be a glass mat or a fibre layer, preferably made from woven or non-woven polyester.

The bitumen-based lower layer is preferably made using a bitumen composition, modified with a polymer selected from the group constituted of atactic polypropylene (APP), poly(styrene-butadiene-styrene) (SBS), polystyrene-b-poly(ethylene butylene)-b-polystyrene (SEBS), polystyrene-b-poly(ethylene-propylene)-b-polystyrene (SEPS), dimethyl-gamma-butyrolactone acrylate (DBA), styrene-isoprene-styrene (SIS), ethylene vinyl acetate (EVA), isotactic polypropylene (IPP), syndiotactic polypropylene (SPP) and the mixtures thereof.

Alternatively, the lower waterproofing layer can be of a vegetable binder base.

### EXAMPLE 2

An upper layer made from a bi-oriented polymer material is constituted of three polyester layers, respectively a first outer layer constituted of PET and TiO₂, a second outer layer made from PET, connected to each other by a central layer constituted of PET and TiO₂ thus forming a bi-oriented polyester multilayer.

A polyester reinforcement comprises a first face and a second face which is equipped with the above-cited bi-oriented polyester multilayer. The first face of the reinforcement is impregnated with a bitumen-based lower layer modified with APP. This enables to obtain a reflecting waterproofing membrane according to the present invention.

The type of reinforcement is not limited to that cited in the present example and can therefore advantageously be a glass mat or a fibre layer, preferably made from woven or non-woven polyester.

The bitumen-based lower layer is preferably made using a modified bitumen composition which could also be selected from the group of compounds cited in example 1.

Alternatively, the lower waterproofing layer can also be of a vegetable binder base.

### EXAMPLE 3

An upper layer made from a bi-oriented polymer material is constituted of three polyester layers, respectively a first outer layer constituted of PET and TiO₂, a second outer layer made from PET, connected to each other by a central layer constituted of PET and TiO₂ thus forming a bi-oriented polyester multilayer.

A polyester reinforcement comprises a first face and a second face which is equipped with the above-cited bi-oriented polyester multilayer. The first face of the reinforcement is impregnated with a bitumen-based lower layer modified with APP. This enables to obtain a reflecting waterproofing membrane according to the present invention.

The type of reinforcement is not limited to that cited in the present example and can therefore advantageously be a glass mat or a fibre layer, preferably made from woven or non-woven polyester.

The bitumen-based lower layer is preferably made using a modified bitumen composition which could also be selected from the group of compounds cited in example 1.

### EXAMPLE 4

An upper layer made from a bi-oriented polymer material is constituted of three polyester layers, respectively a first outer layer constituted of PET and TiO₂, a second outer layer made from PET, connected to each other by a central layer constituted of PET and TiO₂ thus forming a bi-oriented polyester multilayer.

A polyester reinforcement comprises a first face and a second face which is equipped with the above-cited bi-oriented polyester multilayer. The first face of the reinforcement is impregnated with a bitumen-based lower layer modified with APP. This enables to obtain a reflecting waterproofing membrane according to the present invention.

The type of reinforcement is not limited to that cited in the present example and can therefore advantageously be a glass mat or a fibre layer, preferably made from woven or non-woven polyester.

The bitumen-based lower layer is preferably made using a modified bitumen composition which could also be selected from the group of compounds cited in example 1.

Alternatively, the lower waterproofing layer can also be of a vegetable binder base.

### EXAMPLE 5

A polyester reinforcement comprises a first face, which is impregnated with a bitumen-based lower layer modified with APP, and a second face which is equipped with at least one bi-oriented PET layer comprising a pigment, such as TiO₂. This enables to obtain a reflective waterproofing membrane according to the present invention.

The type of reinforcement is not limited to that cited in the present example and can therefore advantageously be a glass mat or a fibre layer, preferably made from woven or non-woven polyester.

The bitumen-based lower layer is preferably made using a modified bitumen composition which could also be selected from the group of compounds cited in example 1.

Alternatively, the lower waterproofing layer can also be of a vegetable binder base.

### COMPARATIVE EXAMPLE 1

A waterproofing membrane successively comprises a first PET and TiO₂-based layer which is not oriented, a reinforcement and a second bitumen-based layer.

It has been observed that such a membrane has a lower lifespan that the membrane according to the invention, in particular that such as defined in example 5 above.

Indeed, the membrane according to this comparative example 1 has an early yellowing. Thus, the membrane is no longer capable of playing the waterproofing role thereof when it is placed on a roof, because of the exudation phenomenon. It is understood that the present invention is not, in any way, limited to the embodiments defined above, and that many modifications can be applied without moving away from the scope of the appended claims.

1. Waterproofing membrane for a roof comprising:
an upper layer made from a polymer material being arranged to reflect UV rays,
a lower waterproofing layer being arranged to cover a roof, and
a reinforcement disposed between said upper layer and said lower layer, characterised in that said polymer material is bi-oriented.

2. Membrane according to claim 1, wherein said bi-oriented polymer material is selected from the group constituted of polypropylene, polyester and the mixtures thereof.

3. Membrane according to claim 1, wherein said upper layer made from a bi-oriented polymer material is a bi-oriented polyester multilayer.

4. Membrane according to claim 1, wherein said polyester is selected from the group constituted of poly(ethylene terephthalate) (PET), poly(ethylene naphthalate) (PEN) and poly(butylene terephthalate) (PBT) and the mixtures thereof.

5. Membrane according to claim 3, wherein said bi-oriented polyester multilayer comprises a pigment selected from the group constituted of titanium dioxide (TiO₂), barium sulphate, calcium carbonate and the mixtures thereof.

6. Membrane according to claim 3, wherein said bi-oriented polyester multilayer comprises a first outer layer, a second outer layer, connected to each other by a central layer.

7. Membrane according to claim 6, wherein said central layer comprises TiO₂ in a quantity of between 0.1-40% by weight, preferably between 0.5-30% by weight, more preferably between 0.6-0.75% by weight, more preferably still between 0.65-0.75% by weight, with respect to the total weight of the central layer.

8. Membrane according to claim 6, wherein said first outer layer and/or said second outer layer comprising TiO₂ in a quantity less than 5% by weight, preferably less than 4% by weight, more preferably between 0.01-3% by weight, with respect to the total weight of said first outer layer and/or said second outer layer.

9. Membrane according to claim 6, wherein said first outer layer and/or said second outer layer comprises PET.

10. Membrane according to claim 4, wherein said PET have an average molecular weight by number within the range going from 18,500-40,000, preferably ranging from 19,000-35,000, more preferably ranging from 20,000-30,000.

11. Membrane according to claim 4, wherein said PET has carboxyl groups in a quantity less than or equal to 30 eq/T, preferably less than or equal to 25 eq/T, more preferably less than or equal to 21 eq/T, more preferably still less than or equal to 15 eq/T, advantageously between 5-15 eq/T.

12. Membrane according to claim 6, wherein said first outer layer and/or said second outer layer comprises a light stabilising agent to absorb UV rays and to reduce the effect of oxygen on the waterproofing membrane, said agent being selected from the group constituted of antioxidants, benzophenones, benzotriazoles, benzoxazinones, triazines, a triazine having 2 phenyl groups or 2 bi-phenyl groups and the mixtures thereof.

13. Membrane according to claim 1, wherein said upper layer made from a bi-oriented polymer material has a thickness of between 3 and 500 μm, advantageously between 10 and 350 μm; 50 and 200 μm, preferably between 80 and 190 μm, more preferably between 180 and 190 μm.

14. Membrane according to claim 1, characterised in that said membrane is reflective.

15. Method for producing a waterproofing membrane according to claim 1, comprising the following steps:
making a reinforcement having a first face and a second face available,
applying a lower waterproofing layer on said first face of said reinforcement,
applying a lower layer made from a bi-oriented polymer material on said second face of said reinforcement.
